(19) United States
(12) Patent Application Publication
(10) Pub. No.: US 2002/0090453 A1
(43) Pub. Date: Jul. 11, 2002

(54) Highly absorbent products and process of making such products

(75) Inventors: Jeno Muthiah, Arlington Hts, IL (US); Gerald K. White, Lake Forest, IL (US); Duane R. Rubash, Antioch, IL (US)

Correspondence Address: Gerald K. White, Esq., GERALD K. WHITE & ASSOCIATES, P.C., Suite 835, 205 W. Randolph Street, Chicago, IL, 60606, US

(73) Assignee: Synergistic Ventures, Inc.

(21) Appl. No.: 09/982,342

(22) Filed: Oct. 18, 2001

Related U.S. Application Data
(60) Provisional application No. 60/242,926, filed on Oct. 25, 2000.

(51) Int. Cl. B05D 1/12; B05D 1/36; B05D 3/06

(52) U.S. Cl. 427/180; 427/475; 427/202; 427/553; 118/638

(57) ABSTRACT

The invention provides processes for coating the surface of polymeric materials such as a sheet, film, foam, fiber, etc., with a curable liquid resin or solution of curable resin, then in one embodiment, stably attaching a superabsorbent polymeric powder to such resin, and then curing the resin to form a coated superabsorbent product. Other process embodiments and resulting products are included in the invention. The coated product has reduced particle agglomeration and particle loss due to the curing step. The product can be interposed between sheets to form disposable absorbent products such as diapers, bandages, etc. or used on one side to form cleaning products.

This patent application claims priority under 35 U.S.C. 119(e) from provisional application Serial No. 60/242,926 filed Oct. 25, 2000 incorporated herein by reference in its entirety.

The present invention relates to highly absorbent products that can, for example, be interposed between liquid permeable and non-liquid permeable sheets to form a disposable absorbent product intended for the absorption of fluids, such as body fluids or used as a wiping sheet and processes of making such products.

### BACKGROUND OF THE INVENTION

Disposable absorbent products currently find widespread use in many applications. For example, in the infant and childcare areas, diapers and training pants have generally replaced reusable cloth absorbent articles. Other typical disposable absorbent products include feminine care products such as sanitary napkins, panty shields, or tampons; adult incontinence products; and health care products such as surgical drapes or wound dressings. A typical disposable absorbent product generally comprises a composite structure including a top sheet, a back sheet, and an absorbent core structure between the top sheet and back sheet. These products usually include some type of fastening system for fitting the product onto the wearer.

The use of water-swellable, generally water-insoluble absorbent materials, commonly known as superabsorbent polymers (“SAP”), in disposable absorbent personal care products is known. Such absorbent materials are generally employed in absorbent products in order to increase the absorbent capacity of such products while reducing their overall bulk. Such absorbent materials are generally present in absorbent products in the form of small particles in a fibrous matrix, such as a matrix of wood pulp fluff. A matrix of wood pulp fluff generally has an absorbent capacity of about 6 grams of liquid per gram of fluff. The superabsorbent materials generally have an absorbent capacity of at least about 10, preferably of about 20, and often of up to 100 times their weight in water. Clearly, incorporation of such superabsorbent materials in disposable absorbent products can reduce the overall bulk while increasing the absorbent capacity of such products.

The absorbent products mentioned above, such as baby diapers, adult incontinence devices, and feminine hygiene products, may be made with a cellulose fiber fluff-based absorbent core sandwiched between a liquid pervious top sheet, which allows the unobstructed passage of fluid to the absorbent core, and a liquid impervious backing sheet usually of plastic material, which contains the absorbed fluid and prevents it from passing through the absorbent core and soiling the undergarments or clothing of the wearer of the absorbent article.

The absorbent core of these absorbent articles may be constructed of defiberized wood pulp with or without superabsorbent polymer granules. The absorbent core may be formed on a pad-forming unit of a converting machine on a carrier tissue to facilitate processing. Some absorbent core forming units are equipped with layering capability in which a second discrete fluff layer may be laid over a primary fluff-based absorbent layer to form a multi-layer absorbent structure. In these absorbent structures, the primary layer may include loose, superabsorbent polymer granules. It is believed that commercially used superabsorbent polymer granules typically have a coarse size distribution. For example, Atofina reported on its website (www.aguakeep-sap.com) on Oct. 15, 2001, that its AQUAKEEP® superabsorbent polymers may be used in diapers and adult incontinence products and have a particle size distribution of less than 0.5% <45 microns, less than 3% >850 microns; with an average particle size distribution of around 420 microns. Such particle size distribution contains a large amount of particles below 850 microns.

In recent years, market demand for thinner and more comfortable absorbent articles has increased. Ultra-thin feminine napkins are no longer constructed from loose wood pulp, which tends to give a bulky product, but with a roll good-based air-laid absorbent cores in which a roll or coil of preformed absorbent core material is unwound directly onto the absorbent pad-making machine without the defiberization step required for fluff-based products. The roll good-based approach results in a product thinness, which cannot be achieved by loose fluff-based technology. As will be seen later, the present invention can produce thinner absorbent products that have the same absorbance properties as thicker products.

Another alternative to using a fibrous matrix containing superabsorbent materials, absorbent foam composites are also known. One form of an absorbent foam composite is wherein a foam material, such as polyurethane, is prepared to include a particulate superabsorbent material within the structure of the polyurethane foam. Alternatively, a particulate superabsorbent material is located between at least two layers of a polyurethane foam material to form a layered composite structure.

U.S. Pat. No. 5,985,434, entitled “Absorbent Foam”, is described to be an improvement to the foamed materials mentioned in the preceding paragraph.

U.S. Pat. No. 6,241,713 entitled “Absorbent Structures Coated with Foamed Superabsorbent Polymer” is described to involve coating a layer of a foamed hydrogel-forming polymer having superabsorbent properties on the surface of a sheeted fibrous absorbent material suitable for use in disposable absorbent products.

U.S. Pat. No. 5,720,832, entitled “Method of Making a Meltblown Nonwoven Web Containing Absorbent Particles”, describes yet another approach to the field of the present invention. This patent may contact freshly extruded microfibers with particles that may be composed of superabsorbent materials. The particles are electrostatically charged and applied to the fibers while such fibers are still tacky following extrusion. The result of such application appears to be a physical adherence of the powder to the wet fiber. Adherence can include embedding the particles into the fiber surface when an embossing technique is used.

U.S. Pat. No. 5,419,955 involves the use of superabsorbent particles and sheets to improve absorbency and retention properties. This technique forms a suspension of the particles to avoid problems with powder agglomeration and powder loss.

The invention of this application avoids the need for tacky, freshly extruded fibers as a starting material in a simple, straightforward manner. Typically such freshly extruded fibers are believed to be sufficiently tacky to function as described in aforementioned U.S. Pat. No. 5,720,832 for less than about one minute following extrusion. Thus, a very narrow processing window exists. Fibers or other materials that have been made and stored over a period of time longer than about one minute prior to coating and powder coating may be utilized in this invention. Also, while the need to use particle-containing suspensions is avoided, the objectives of avoiding powder agglomeration and powder loss are achieved by this invention. Accordingly, the objectives of the prior art are achieved without the accompanying constraints.

### SUMMARY OF THE INVENTION

The process of the present invention involves coating the surface of a polymeric material, such as fiber, sheet, foam, film, etc., with curable liquid resin compositions such as acrylates, unsaturated polyesters, epoxies, urethanes, acrylics, monomer-containing liquids that become superabsorbent when polymerized or cured, etc., applying a superabsorbent polymeric powder to the coating, and then curing the said coating to cause the powder to adhere to the coated polymeric material. It is possible to form a superabsorbent polymer coating by applying monomer-containing liquid resins to the polymeric material surface prior to applying the superabsorbent polymeric powder and then curing the liquid resin particle coating. Curing or polymerizing the monomer will create the desired superabsorbent polymer coating and also adhere the superabsorbent particles thereto. It is also contemplated that a superabsorbent coating, without superabsorbent polymer powders or particles, could be utilized in absorbent materials if so desired. Curing may be effected by thermal or radiation means or a combination thereof. UV curing offers a convenient curing process for said monomer-containing liquid resins.

The present invention also comprises a product having a polymeric material with an at least partially cured resinous coating and further having a superabsorbent polymeric powder adhered to such coating to form a stable, highly absorbent product that can be used for example, as a disposable absorbent product for the absorption of fluids, including body fluids or as a wiping cloth.

As can be appreciated, several long-standing problems in the art are solved by the invention; namely, superabsorbent polymer particle agglomeration and loss; the need for a freshly formed fiber as a starting material (such as the extruded fibers of U.S. Pat. No. 5,720,832); and the need for particle-containing suspensions (such as shown in U.S. Pat. No. 5,419,955). The particles of this invention are located at the surface of the coating rather than mixed within a suspension and thus, effectively disposed to contact and absorb the fluid.

More specifically, the present invention is advantageous over the above discussed prior art because it can stably adhere particles to coated polymeric surfaces. Such result is achieved through use of a liquid resinous coating on the polymeric surface with subsequent curing to adhere the coating to the polymeric material and to the superabsorbent polymeric powder particles. These techniques reduce agglomeration, powder loss, and migration of such powder through the product to the user's skin. Adherence of the particles offers a further advantage due to improved migration of absorbed liquids or fluids from the superabsorbent polymer particles into the coating and polymeric material, thus, the overall absorbency of the absorbent product is enhanced because of stable adherence. Thus, one of the major problems in prior art products is addressed by the present invention through increased migration of such liquids or fluids into other portions of the absorbent product. The invention also requires less bulk than conventional products thereby reducing solid waste disposal space.

The absorbent products of the present invention are suited for use in disposable products including disposable absorbent products such as diapers, diaper liners, training pants, wraps and covers, adult incontinence products, and bed pads; incontinence devices; feminine hygiene products such as sanitary napkins, panty shields, or tampons; other absorbent products such as wipes, bibs, wound dressings and surgical capes or drapes, mattress covers and puddle pads. Accordingly, in another aspect, the present invention relates to a disposable absorbent product utilizing the absorbent products of the present invention as a component.

### DETAILED DESCRIPTION OF THE PREFERRED EMBODIMENTS

Polymeric materials may include the superabsorbent polymers set forth below or non-superabsorbent polymers such as polyurethane, polyester, polyethylene, cellulosic, polyolefin, and the like.

It is also contemplated by the invention to utilize co-extruded fibers having a non-superabsorbent polymeric core with a superabsorbent polymeric outer layer as a polymeric material.

Superabsorbent polymeric powders suitable for use in the present invention include, but are not limited to, a wide variety of anionic, cationic, and nonionic materials. Suitable polymers include polyacrylamides, polyvinyl alcohols, ethylene maleic anhydride copolymer, polyvinylethers, polyacrylic acids, polyvinylpyrrolidones, polyvinylmorpholines, polyamines, polyethyleneimines, polyquatemary ammoniums, natural based polysaccharide polymers such as carboxymethyl celluloses, carboxymethyl starches, hydroxypropyl celluloses, algins, alginates, carrageenans, acrylic grafted starches, acrylic grafted celluloses, chitin, chitosan, and synthetic polypeptides such as polyaspartic acid, polyglutamic acid, polyasparagins, polyglutamines, polylysines, and polyarginines, as well as the salts, copolymers, and mixtures of any of the foregoing polymers.

Curable liquid resins for coating the above-mentioned polymeric materials include acrylates, unsaturated polyesters, epoxies, urethanes, acrylics, monomer- containing liquids that become superabsorbent when polymerized or cured, etc. Because urethanes and superabsorbent polymers absorb moisture, such resins can also contribute to liquid absorption and thus further increase the total absorbency. In this regard, superabsorbent polymers are preferred to urethanes from the standpoint of maximizing the overall liquid absorbency of the absorbent product.

The liquid resins can be applied or coated on the surface of the polymeric material by conventional techniques such as misting, spraying, dipping, curtain coating, slot coating, immersion, aspiration, and the like. Alternatively, the resin may be placed in solution, coated on the polymeric material in liquid solution form, and the solvent then evaporated to leave a highly concentrated coating of the resinous material on the surface of the polymeric material. The balance of the solvent will be evaporated following adherence of the superabsorbent powder particles to the concentrated coating. Polyacrylic acid dissolved in water is a suitable liquid coating. Other combinations of materials and solvents are considered to be part of the invention. Water is a preferred solvent due to environmental factors, but organic solvents such as ethanol and methanol, would also function as a solvent. Evaporation can be achieved by simply sitting at room temperature or accelerated by a temperature increase.

As mentioned above, a liquid-containing monomer may be coated onto the surface of a polymeric material and then cured to form a superabsorbent polymeric coating. While the monomer is in liquid form, superabsorbent powder may be applied to the liquid coating and followed by curing of the liquid by thermal or radiation means. Electrostatic charging of the powder prior to application is optional. Such procedure will cure the liquid monomer-containing resin and stably adhere the powder to the cured coating. In some instances, powder application may not be necessary and reliance can be solely placed on the superabsorbent coating. For example, where the polymeric material is fibrous in nature, a superabsorbent polymer coating without the need for superabsorbent powders could be satisfactory due to the relatively large surface and that a fiber provides as contrasted with a sheet, foam, or film which have lesser surface areas per unit of weight.

Superabsorbent polymeric powders or particles are applied to the liquid resin coated surface of polymeric material through contact. Advantageously, such application can be achieved by directing a stream of superabsorbent polymeric powder particles against the coated polymeric surface. Such streams may be airborne and, if the particle does not readily adhere to the coating, the particles may be electrostatically charged by corona discharge or tribocharging to improve initial adherence prior to at least partially curing said applied coating. Such techniques will serve to improve transfer efficiency of the powder. Another technique is to incorporate additives into the resinous coating composition to improve powder attraction. Surfactants, such as a sodium salt of a sulfonic acid and ammonium salts with long aliphatic chains and the like, are suitable.

Alternatively, a superabsorbent polymeric powder could be applied to a polymeric material surface and then such applied powder can be adhered through the application of a resinous coating and subsequent curing. Said coating may be a liquid resin or a resinous coating powder, which transforms to a solid coating upon curing. Conventional thermosetting or thermoplastic resinous powder coatings are suitable. Curing may be thermal or radiation. The curing temperatures and/or radiation curing procedure will cure the liquid resin or resinous coating powder but the superabsorbent polymeric powders, unlike the resinous liquid or powders, will remain in the same solid particle state because such superabsorbent powders will not melt, flow or otherwise transform during curing. This procedure would serve to contain or adhere the superabsorbent polymeric powder between the polymeric material and coating, thereby achieving the aforesaid advantages of the present invention.

Another embodiment of the process mentioned in the preceding paragraph comprises applying superabsorbent polymeric powders that are coated with a resinous material to a polymeric material and then curing the resinous coating on such powders. Curing results in the cure of the resinous outer coating but does not alter the superabsorbent polymeric powder. Adherence to the polymeric materials is obtained through adhesion of such cured outer coating. Such coated powders could also be contained in a mixture, emulsion, etc.

Another embodiment for adhering superabsorbent polymeric powder to a polymeric material comprises providing a mixture of a superabsorbent polymeric powder and a resinous coating powder, applying such mixture to the polymeric material, and then curing the applied powder mixture to cause adherence to the surface of the polymeric material. Electrostatic charging of the powders prior to application is optional. Curing may be effected by thermal or radiation means. Powder mixing may be performed prior to application, conveniently in a fluidized bed. Mixing may also be performed with use of separate application means (conveniently two or more Corona discharge guns that are so directed toward the surface of the polymeric material) to cause mixing of the respective powders prior to application. Again, the resulting cured product contains superabsorbent polymeric powders contained in a cured resinous coating, which is adhered to the surface of the polymeric material. As above, curing will not alter the state of the superabsorbent polymeric powder.

In any event, once the powder particles are adhered to the coated surface, curing of the coating is effected to further enhance and stabilize the powder coating. Thermal curing through heating to from about 30° to 200° C. for times from about one second to 20 minutes represents typical conditions. Thermal curing can be, for example, achieved in electric, gas fired or induction heated ovens, infrared or microwave heating. Typically, higher temperatures require shorter curing times. Radiation curing can be accomplished by exposure of the coating to ultraviolet, electron beam radiation, etc. Radiation curing, especially by ultraviolet light, is attractive due to its low temperature aspects and consequent lack of potential harm to the polymeric surface. Typically, the coating can be cured using V or D lamps with an illumination dosage of 200 to 600 watts per linear inch discharge. Also a dual cure utilizing thermal and radiation curing is contemplated. Dual curing can be accomplished step-wise or simultaneously. In any event, curing is effective to reduce the tendency of the powder to agglomerate and separate from the coated surface of the polymeric material and also is effective to reduce the loss of fine particles.

Full curing may not be required in that curing to the extent to permit handling and avoid undesirable tackiness is sufficient.

In general, relatively fine particle size distributions are preferred to coarse particle size distributions due to larger surface area and thus, the ability to increase absorbency within normal product usage times. Such increased absorbency reduces the weight of the final product and thus permits a smaller amount of superabsorbent polymer to be used. Such fine particle sizes, within normal produce usage times, in addition to increasing the amount of overall liquid that can be absorbed per unit of superabsorbent polymer, also serve to increase the rate of liquid absorbance. The relatively coarse particle size distribution believed to be used commercially, i.e., having and described in the previously-mentioned website of Atofina, an average particle size of 420 microns, is suitable to achieve certain of the advantages of the invention if attached to the cured coating of the invention. Such certain advantages of the present invention involve stable adherence of the powder to the coated polymeric material, thus minimizing loose powder and powder agglomeration as well as promoting liquid migration throughout the absorbent product. In general, particle size is not essential to attaining such advantage, but as discussed in the next paragraph, particle size distributions less than the coarse commercial powder offer additional advantages.

Smaller particle size distributions can provide other important advantages. First of all, size distributions smaller than the above-discussed coarse size distribution provide increased absorbency rates and, within normal product usage times, provide greater total absorbance. For example, a powder having a large proportion of its particles below about 200 microns exhibits markedly improved absorbance properties when contrasted to a powder having a coarse particle size distribution, such as the above-mentioned Atofina superabsorbent powder. Further benefits may be achieved with particle size distributions wherein a large proportion of the particles are below about 100 microns or even lower.

As can be appreciated, the property relationship that smaller particle size distributions enhance the overall or total amount of liquid that can be absorbed per unit of weight of superabsorbent polymer may enable the absorbent product manufacturer to utilize a smaller amount or weight of superabsorbent polymers and yet achieve the same amount of absorbency achieved by larger particles of the same weight. Such advantage results in the ability to produce smaller, less costly absorbent products that have the same absorbency as that of more bulky products. Another absorbance property of significance is that the smaller the particle size distribution, the higher the rate of liquid absorbance. This property can be utilized advantageously for absorbent products where comfort and hygiene are considered to be important, such as diapers, adult incontinence products, and other absorbent products which absorb body fluids, and the like. Obviously, the combination of improved rate of absorbance coupled with improved total absorbance would especially contribute to the comfort of the user of diapers and adult continence products.

One criteria for selection of a particle size for commercial use is believed to be one of economics; that is, a balance between the cost to achieve a given absorbency benefit vs. the cost savings realized in being able to use a lesser amount of superabsorbent polymer. Thus, cost considerations could result in not using very small sized particles even though the above-mentioned absorbency properties and advantages could be obtained thereby. It is also pointed out that smaller particles, in general, are believed to be more adherent to the liquid resin coating than more coarse particles. On the other hand, very fine particles, such as less than 10 microns, could involve handling and processing problems.

It is also contemplated that foamed starting materials such as fibers and sheets and foamed powders can further improve fluid absorbency due to an increase in respective surface areas. In the instance of foamed sheets, it is noted that above- mentioned U.S. Pat. No. 5,985,434 utilizes a water-swellable, water insoluble polymeric foam having an average cell size between about 10 microns to about 100 microns with about 10 to about 50 microns being preferred. It is also contemplated that foamed fibers can be used as a polymeric material to be coated. Foaming of polymeric materials such as sheets, films, fibers, etc., creates even more surface area for coating and absorbency and thus the respective particle sizes of the powder and cells should be compatible.

Foamed polymeric materials can be present in the absorbent foam in a weight amount that is between about 50 weight percent to 100 weight percent, beneficially between about 60 weight percent to about 100 weight percent, more beneficially between about 70 weight percent to about 100 weight percent, suitably between about 80 weight percent to about 100 weight percent, more suitably between about 90 weight percent to about 100 weight percent, and even more suitably between about 95 weight percent to about 100 weight percent, wherein all weight percents are based on the total weight amount of the polymer, and crosslinking agents, and any other optional components present in the absorbent foam. In one embodiment, it is desired that the absorbent foam consist essentially of the polymer and, optionally, any crosslinking agent used to crosslink the polymer. As will be appreciated by one skilled in the art, such an absorbent foam may also comprise an insubstantial amount of solvent retained from the preparation process and/or an insubstantial amount of water vapor absorbed from the air. In general, the presence of any materials in the absorbent foam that are not the water-swellable, water-insoluble polymer will tend to reduce the overall liquid absorbency capacity of the absorbent foam. Such foams are disclosed and further described in above-mentioned U.S. Pat. No. 5,985,434.

Powders suitable for the invention may be made using conventional techniques such as extrusion and grinding. Production of very fine size distributions such as less than 10 microns, and even from 2 to 5 microns, can be manufactured with the use ofjet milling or other technology. Direct particle production such as shown in U.S. Pat. Nos. 5,766,522; 5,708,039; 4,582,731; 4,734,451; 4,012,461; 5,027,742; 5,171,613; 4,734,227; 5,997,956; and 6,132,653 can also be used to produce particles for the invention. Said patents are incorporated herein by reference. It is also contemplated that directly produced particles or powders can be generated and then immediately placed in contact with the liquid coated polymeric material.

Above-mentioned U.S. Pat. No. 5,766,522 discloses the use of supercritical conditions to produce resinous particles. Carbon dioxide may be used as a solvent for the process. The Ohio State University College of Engineering, in its publication entitled, “News in Engineering”, Vol. 70, No. 2, describes the treatment of polymers under supercritical conditions to expand polymer fibers to increase absorbency. This publication also discloses supercritical carbon dioxide can carry additives, such as molecules of surfactants or soaps, deep into materials such as cloth, plastic, and paper. However, there is no mention of carrying superabsorbent particles into such materials.

The process of the present invention permits incorporation of superabsorbent material (powder or film) into polymeric materials by treating the polymeric material with a superabsorbent material contained in supercritical fluid solvents, such as carbon dioxide methanol, etc. Aforementioned U.S. Pat. No. 5,766,522 mentions various other suitable solvents.

It is contemplated by the present invention that resinous superabsorbent polymer particles or films could be generated in situ under supercritical conditions and then incorporated into a polymer that is being treated supercritical conditions, such as with supercritical carbon dioxide. Alternatively, premanufactured particles could be added under supercritical conditions to achieve incorporation. Under either process, liquid absorbency of the treated polymer would be increased, thereby offering a new class of highly absorbent products.

The invention may also be advantageously used to enhance the absorbency of cleaning products designed for wiping or absorbing liquids, particularly aqueous liquids, such as water or water-based liquids. Such products made according to the present invention exhibit increased rates of absorbency, especially during initial stages of use. Particle size distribution is important to achieve the rapid aqueous absorption rates required for wipes. To demonstrate this inventive characteristic, the absorbency data set forth below was obtained. Three different 0.1 gram powders, each having different particle size distributions, were placed in filter bags made from USA filter paper, which was made from non-chlorinated blended fibers and sold by Miniminit Products, Ltd., Scarborough, Ontario, Canada, and then immersed in a cup of distilled water for thirty seconds. The superabsorbent particles of Samples A and B were obtained from Aquatine, Inc., P.O. Box 5168, Lakeland, Fla. 33807, and sold under the name AOG-40 and AOG-44. Sample C was obtained by grinding and screening a portion of Sample B to a smaller size. The following experimental results were obtained and are set forth in the following Table.

| | SAP | Weight Gain | |
|---|---|---|---|
| | Particle Size | Including | Appearance of SAP |
| Sample | Distribution | Filter Bag | Following Immersion |
| A | 100% > 210 | 2.0 | Ball-like discreet |
| (AOG-40) | microns | | particles contain |
| | | | absorbed water |
| B | 100% < 210 | 18.9 | Gel- or paste-like |
| (AOG-44) | microns, | | material containing |
| | 35% < 90 | | absorbed water |
| | microns | | |
| C | 100% < 90 | 19.7 | Gel- or paste-like |
| (AOG-44, ground | microns | | material containing |
| and screened) | | | absorbed water |

Based upon the above data, it is clear that the gel- or paste-like resulting material exhibited much superior absorbance. Hence, a sufficiently small size distribution to achieve such gel-like material results in a superior wipe. Clearly, an SAP particle size distribution having a large proportion of particles less than 200 microns would achieve such gel and accompanying desired result. Sample C is consistent with the result of Sample B and achieves further superior absorbency.

As can be appreciated, the powder stably adhered to the cured resin coating should have a particle size distribution sufficient to form a gel upon contact with aqueous solutions. A convenient powder particle size distribution to form a gel is one having essentially about 100% of its particles below about 200 microns and 35% below about 100 microns. Finer particle size distributions, such as those having about 100% of its particles below about 100 microns, are believed to be further advantageous.

It should be understood that a wipe could comprise a polymeric material having a cured liquid resin and adhered superabsorbent powder on one or both wipe surfaces. Alternatively, an absorbent core of the above-coated material could be interposed between two water permeable sheets or between one water impermeable sheet and one water permeable sheet.

Two different SAP particle size distributions were evaluated to simulate conditions encountered during the use of a diaper. One-gram samples of each particle distribution were placed in the same filter papers described above. Samples and B correspond to Samples A and B of the above wiping experiments. The samples were immersed in a container having 0.9% wt% sodium chloride in water for five time intervals. This sodium chloride-containing solution was provided to simulate urine. the following experimental results were obtained and are set forth in the following Table.

| | | Weight Gain per one gram | | | | |
|---|---|---|---|---|---|---|
| | SAP | of Super Absorbent Polymer (in grams) | | | | |
| | Particle Size | after specified time (in minutes) | | | | |
| Sample | Distribution | ½ min | 1 min | 5 min | 10 min | 30 min |
| A | 100% > 210 | 7.69 | 11.58 | 19.52 | 27.60 | 33.85 |
| (AOG-40) | microns | | | | | |
| B | 100% < 210 | 27.59 | 31.04 | 34.01 | 34.32 | 34.36 |
| (AOG-44) | microns, | | | | | |
| | 35% < 90 | | | | | |
| | microns | | | | | |

Based on the previously mentioned Atofina website, a typical diaper may contain anywhere about 10 grams to 20 grams of superabsorbent polymer. Normal diapers typically utilize about 10 grams or less of SAP and thinner diapers, pads, or adult incontinence products, contain from 10 to 20 grams of SAP. In general, the thinner the product, the higher amount of SAP that is included. Two diapers are weighed after usage, and the weight gain is approximately 200 grams. If 10 grams of SAP was used, then the weight gain per gram of SAP is about 20 grams. This indicates that normal usage time of a diaper corresponds to 5 and 10 minutes of the above experimental times. At 5 and 10 minutes, the difference in weight gain between respective particle sizes is very significant. The particles of Sample B can absorb about 75% more at 5 minutes and 25% more at 10 minutes. This indicates that the usage of SAP in diaper products may be reduced by at least 25% by weight, and similar performance with respect to the total absorbency of the diaper can be maintained. Another benefit is that the faster rate of absorption of the finer particles will maintain the contact surface drier than coarse particles.

The above data also indicate that thin absorbent products, such as adult incontinence products, can benefit to a greater extent regarding contained SAP weight than normal diapers because of the higher amount of the contained SAP. Another benefit is that such desirably thin products can be made even thinner without loss of important absorbency properties.

It is believed that the above Table indicates that finer particles lead to increased rates of absorbance, at least during initial usage times. Finer particles, at least during normal diaper usage times (prior to saturation) are believed to lead to increased total absorbance. Please note that the data following the 30 minutes of immersion is believed to reflect product saturation —an event that would rarely occur during actual use. It is believed that the data obtained following up to 10 minutes of immersion is more typical of actual use.

A general example of a typical combination of process steps that can produce the product of the invention is as follows:

First, a sheet of cellulosic fibers is provided and then is spray coated with a UV-curable liquid urethane resin. Then such coated fibrous material is contacted with superabsorbent polymeric powders comprised of sodium salts of polyacrylic acid having a size distribution wherein a large proportion of the particles are less than about 200 microns and thus is caused to adhere to the liquid resinous coating. This intermediate product is then exposed to ultraviolet radiation from H lamps with less than one second exposure to cure the resin and thereby stably affix or stably adhere the powder particles to the surface of the cured resin. The resultant sheet product is no longer tacky following the curing step and is then stacked with like sheets to form a liquid absorbent product or core which is then disposed between a liquid permeable sheet and a non-liquid permeable sheet to form a diaper.

Another process embodiment is illustrated below.

A sheet of cellulosic fibers is provided and then is coated with an aqueous solution containing a polyacrylic acid resin. Following evaporation of the water at a low temperature such as 100° F., the same powder described in the example is applied and the process is conducted in the same manner. A resultant product similar to that of the above example is obtained.

It will be understood that a coil of cellulosic material could be used instead of an individual sheet and the process conducted in a continuous manner passing the coil web through various processing stations. The web can then be recoiled or individual sheets cut from the coil following the curing step. Also individual sheets can be placed in a moving belt and continuously or semi-continuously moved from a coating station to a powder application station, to a curing station, and to a stacking station.

1. A process for adhering superabsorbent polymeric powder onto polymeric material comprising:
a) Providing a polymeric material;
b) Applying a curable liquid resin to a surface portion of said polymeric material to form a coating thereon;
c) Applying a superabsorbent polymeric powder to a surface portion of said coating; and
d) Causing said powder to be adhered to said coating surface portion by at least partially curing said coating following application of said powder thereby forming a polymeric material having a cured resinous coating and powder stably adhered to said polymeric material.

2. The process of claim 1, wherein said curing is at least partially caused by radiation curing.

3. The process of claim 1, wherein said powder and said polymeric material comprise the same polymer.

4. The process of claim 1, wherein said powder is subjected to an electrostatic charge prior to being applied to said surface portion of said coating.

5. The process of claim 1, wherein said polymeric material is selected from the group consisting of superabsorbent polymers, non-superabsorbent polymers, and a combination thereof.

6. The process of claim 5, wherein said combination comprises a coextruded fiber having a non-superabsorbent polymeric core and a superabsorbent polymeric outer layer.

7. The process of claim 1, wherein said polymeric material is at least partially foamed.

8. The process of claim 1, wherein said powder is at least partially foamed.

9. The process of claim 7, wherein said powder is at least partially foamed.

10. The process of claim 1, wherein said powder has a particle size distribution with a large proportion of its particles less than 850 microns.

11. The process of claim 1, wherein said powder has a particle size distribution wherein a large proportion of its particles are below about 200 microns.

12. The process of claim 1, wherein said powder has a particle size distribution wherein a large proportion of its particles are below about 100 microns.

13. The process of claim 1, wherein said curable resin is a liquid selected from the group consisting of acrylates, unsaturated polyesters, epoxies, urethanes, acrylics, a monomer-containing liquid capable of forming a superabsorbent polymer upon polymerization, and mixtures thereof.

14. The process of claim 13, wherein said curable liquid resin comprises a urethane.

15. The process of claim 13, wherein said curable liquid resin comprises a monomer-containing liquid capable of forming a superabsorbent polymer upon polymerization.

16. A process for coating a superabsorbent polymer on polymeric material comprising:
a) Providing a polymeric material;
b) Applying a monomer-containing liquid resin onto a surface portion of said polymeric material to form a coating thereon; and
c) Curing said monomer-containing liquid resin to polymerize said resin into a superabsorbent polymer, thereby forming a coating on said polymeric material.

17. The process of claim 16, wherein said curing is caused by radiation.

18. The process of claim 16, which further includes the step of applying a superabsorbent polymeric powder to said liquid resin prior to curing.

19. The process of claim 18, wherein said powder is subjected to an electrostatic charge prior to being applied to said surface portion of said coating.

20. A product made by the process of claim 16.

21. A product made by the process of claim 18.

22. A process for adhering superabsorbent polymeric powder onto polymeric material comprising:
a) Providing a polymeric material;
b) Applying a solution of a curable resin in a solvent to a surface portion of said polymeric material to form a coating thereon;
c) Evaporating at least a portion of said solvent;
d) Applying a superabsorbent polymeric powder to a surface portion of said coating; and
e) Causing said powder to be adhered to said coating surface portion by at least partially curing said coating following application of said powder thereby forming a polymeric material having a cured resinous coating and powder stably adhered to said polymeric material.

23. The process of claim 22, wherein said solution comprises polyacrylic acid dissolved in water.

24. A product made by the process of claim 1.

25. A product for absorbing liquids comprising a polymeric material having a coating of an at least partially cured resin stably adhered to a superabsorbent polymeric powder.

26. The product of claim 25, wherein said polymeric material is selected from the group consisting of superabsorbent polymers, non-superabsorbent polymers, and a combination thereof.

27. The product of claim 26, wherein said combination comprises a coextruded fibrous material having a non-superabsorbent polymeric core and a superabsorbent polymeric outer layer.

28. The product of claim 25, wherein said polymeric material contains at least a foamed portion.

29. The product of claim 25, wherein said powder has a particle size distribution with a large proportion of its particles less than 850 microns.

30. The product of claim 25, wherein said powder has a particle size distribution with a large proportion of its particles less than 200 microns.

31. The product of claim 25, wherein said powder has a particle size distribution with a large proportion of its particles less than 100 microns.

32. The product of claim 25, wherein said powder and said polymeric material are comprised of superabsorbent polymers.

33. The product of claim 25, wherein said superabsorbent polymers are essentially the same polymer.

34. The product of claim 25, wherein said polymeric material is at least partially foamed.

35. The product of claim 32, wherein said powder is at least partially foamed.

36. The product of claim 34, wherein said foam comprises a water-swellable, water-insoluble polymer wherein the water-swellable, water-insoluble polymer is present in the absorbent foam in a weight amount between about 50 weight percent to 100 weight percent, based on the total weight of the absorbent foam, and wherein the absorbent foam exhibits a free swell value of at least about 10 grams of liquid per gram of absorbent foam and a softness value that is less than about 30 grams of force per square meter of the absorbent foam.

37. The product of claim 25, wherein said at least partially cured resin is selected from the group consisting of acrylates, unsaturated polyesters, epoxies, urethanes, acrylics, superabsorbent polymers, and mixtures thereof.

38. The product of claim 37, wherein said at least partially cured resin comprises a urethane.

39. The product of claim 37, wherein said at least partially cured resin comprises a superabsorbent polymer.

40. A liquid absorbent composite product comprising:
a) A liquid permeable first sheet;
b) A second sheet attached to said first sheet; and
c) A liquid absorbent core disposed between said first and second sheets;
said core comprising a polymeric material having a coating of an at least partially cured resin having superabsorbent polymeric powder adhered to said coating.

41. The product of claim 40, wherein said core comprises the product of claim 1.

42. The product of claim 40, wherein said core comprises the product of claim 22.

43. The product of claim 42, wherein said core comprises the product of claim 25.

44. The product of claim 40, wherein said core comprises the product of claim 28.

45. The product of claim 40, wherein said core comprises the product of claim 29.

46. The product of claim 40, wherein said core comprises the product of claim 30.

47. The product of claim 40, wherein said composite product is a diaper.

48. The product of claim 40, wherein said composite product is a cleaning product.

49. The product of claim 40, wherein said composite product comprises the product of claim 39.

50. A process for making a cleaning product, comprising:
a) Providing a polymeric material;
b) Applying a curable liquid resin to a surface portion of said polymeric material to form a coating thereon;
c) Applying a superabsorbent polymeric powder to a surface portion of said coating, said powder having a particle size distribution sufficient to form a gel upon contact to aqueous solutions; and
d) Causing said powder to be adhered to said coating surface portion by at least partially curing said coating following application of said powder thereby forming a polymeric material having a coating and powder stably adhered to said polymeric material.

51. The process of claim 50, wherein said superabsorbent polymeric powder has a particle size distribution with a large proportion of its particles less than about 200 microns.

52. The process of claim 50, wherein said superabsorbent polymeric powder has a particle size distribution with a large proportion of its particles less than about 100 microns.

53. The process of claim 50, wherein said curing is effected by radiation.

54. The process of claim 50, wherein said powder is electrostatically charged prior to applying said powder to said coating.

55. A cleaning product for absorbing aqueous liquids comprising a polymeric material having a coating of an at least partially cured resin stably adhered to a superabsorbent polymeric powder having a particle size distribution sufficient to form a gel upon contact with an aqueous solution.

56. The product of claim 55, wherein said particle size distribution of said powder with a large proportion of its particles less than about 200 microns.

57. The product of claim 55, wherein said superabsorbent polymeric powder has a particle size distribution with a large proportion of its particles less than about 100 microns.

58. A process for incorporating superabsorbent polymeric material into polymeric material comprising treating a polymeric material with a supercritical fluid containing superabsorbent polymeric material to cause said superabsorbent polymeric material to be incorporated into said polymeric material.

59. The process of claim 58, wherein said fluid comprises carbon dioxide.

60. The process of claim 58, wherein said superabsorbent polymeric material is a preformed powder that is mixed with said supercritical fluid.

61. The process of claim 58, wherein said superabsorbent polymeric material is generated in situ in said supercritical fluid.

62. The process of claim 61, wherein said superabsorbent polymeric material comprises a powder.

63. The process of claim 58, wherein said polymeric material comprises a fiber.

64. An absorbent product comprising a polymeric material having a superabsorbent polymeric material incorporated therein.

65. The product of claim 64, wherein said polymeric material comprises a fiber.

66. The product of claim 64, wherein said superabsorbent polymeric material comprises a particle.

67. The product of claim 64, wherein said superabsorbent polymeric material comprises a film.

68. A diaper containing the product of claim 64.

69. A process for adhering superabsorbent polymeric powder onto polymeric material comprising:
a) Providing a polymeric material;
b) Applying a superabsorbent polymeric powder to a surface portion of said polymeric material;
c) Coating said powder coated polymeric material with a resinous material; and
d) Causing said superabsorbent polymeric powder to be contained or adhered to said polymeric material by at least partially curing said resinous material.

70. The process of claim 69, wherein said polymeric material is liquid permeable.

71. The process of claim 69, wherein said resinous material comprises a liquid.

72. The process of claim 69, wherein said resinous material comprises a powder.

73. An absorbent product comprising a polymeric material having a coating comprising a superabsorbent polymeric powder and an at least partially cured resinous material.

74. A diaper comprising the product of claim 73.

75. A process for adhering superabsorbent polymeric powder onto polymeric material comprising:
a) Providing a polymeric material;
b) Applying a superabsorbent polymeric powder which is coated with liquid resinous material to a surface of said polymeric material; and
c) Causing said applied powder to adhere to said polymeric material by at least partially curing said liquid resinous material.

76. A product made by the process of claim 75.

77. A process for adhering a superabsorbent polymeric powder onto a polymeric material comprising:
a) Providing a polymeric material;
b) Applying a mixture comprising a superabsorbent polymeric powder and a resinous coating powder to a surface of said polymeric material;
and
c) Causing said applied powder mixture to adhere to said polymeric material by at least partially curing said powder, thereby obtaining a coating comprising a cured coating powder containing said superabsorbent polymeric powder.

78. The process of claim 77, further comprising electrostatically charging said powder mixture prior to applying said mixture to said polymeric material.

79. The process of claim 77, wherein said curing is effected by radiation.

80. The product made by claim 77.
